(19) United States
(12) Patent Application Publication
(10) Pub. No.: US 2004/0172992 A1
(43) Pub. Date: Sep. 9, 2004

(54) Screw lock

(76) Inventor: Yung-Chen Huang, Fongyuan City (CN)

Correspondence Address: APEX JURIS, PLLC, 13194 EDGEWATER LANE NORTHEAST, SEATTLE, WA, 98125, US

(21) Appl. No.: 10/475,487

(22) PCT Filed: Apr. 26, 2001
(86) PCT No.: PCT/CN01/00618

(51) Int. Cl. E05B 27/06; E05B 19/06

(52) U.S. Cl. 70/358; 70/409

(57) ABSTRACT

The present invention relates to a screw lock, wherein a core is provided in the interior of the body, a key hole formed to be a fork shape is provided in the center of the core in axle direction, and the screw holes have some pins respectively; a front end of the key corresponding to the key hole and the pins is designed to be a fork-like screw shank with many teeth. When the key is screwed into the key hole of the core, each of the teeth may raise a pin to the unlock position.

### BACKGROUND OF THE INVENTION

1. Field of the Invention

This invention is about a kind of lock, in especial with refers to a kind of lock whose key and key hole both possess multiple fork screw shape, can promote the function effectively to prevent unlocking unlawfully.

2. Description of the Prior Art

Generally selling all kinds of locks in the market, but whose forms can be divided roughly as: flat [symbol] round [symbol] and cross etc. Their interior pins are arranged mostly by linear arrangement way line-up. Because pins of these flat [symbol] round [symbol] and cross locks all present linear arrangement, and the space of the key hole can admit of insertion of special tool, so it is easier to be gouged or use other tool which is not fitting key to unlock unlawfully by thief.

Besides, there is a kind of square thread screw lock sold on the market. Whose key hole is single line screw shape and whose pins present linear arrangement. So the number of whose pins is less and the key hole space of installation position of pin is relatively wide. It can't effectively prevent special tool to move pins by comparison. In addition, because the slide of pin along key's radial direction and toward center is limited by the interior spring of the hollow key, cause the effective slide distance of pin is smaller (for the key of typical diameter 6 mm, the effective slide distance of pin is about 1.5 mm) and useful number of section of every set of pin is less. So this kind of conventionally used square thread screw lock still has space in addition to improve on the function of defence against robbers

Examining the defect of the technique conventionally understood and stated above, the inventor of this invention then proposes a kind of multiple fork screw lock. Take the pins which arrange by linear way originally change to arrange by screw shape way to promote the lock's ability of defence against robbers effectively.

### SUMMARY OF THE INVENTION

The purpose of this invention is to provide a kind of screw lock. Whose key hole possesses multiple fork sections form the space inside the hole is smaller than all of flat [symbol] round [symbol] and cross key holes. The special tool which can admit of insertion is the smallest. So the probability can be gouged or use other tool which is not fitting key to unlock unlawfully by thief is the smallest too. It possesses the function of preventing unlocking unlawfully is more excellent than conventionally used lock.

Another purpose of this invention is to provide a kind of multiple fork screw lock. That can fit in body and other fittings. And every kind of locks, for example door lock [symbol] U shape lock, will be manufactured.

The screw lock which can achieve the invention purpose stated above includes: a core, establishes a key hole of multiple fork screw shape in whose center, fills every screw hole which is inside the key hole with multiple pin individually; And a key, the part of front end use to revolve into key hole is a multiple fork-like screw shank matches the key hole. And the position where the key rod homologizes every pin seemly carves with tooth of different depth, make use of containing and pushing highly every pin individually to an unlock position.

Among the multiple fork screw lock stated prior, key rod of key's front end and key's handle seemly can be connected by relatively rotated way, so that when unlock, key can screw into key hole.

Among the multiple forks screw lock stated prior, the key hole of multiple fork screw shape fits to be the key hole of three forks screw shape, and multiple fork-like screw shank fits to be three fork-like screw shank.

### BRIEF DESCRIPTION OF THE DRAWINGS

The drawings disclose an illustrative embodiment of the present invention which serves to exemplify the various advantages and objects hereof, and are as follows:

FIG. 1 is stereo part sectional drawing of screw lock of this invention,

FIG. 2 is stereo part section diagram of core among the screw lock,

FIG. 3 shows axial part sectional drawing of screw lock; and

FIG. 4 is axial part sectional drawing of this case's screw lock when applies to U shape lock.

### DETAILED DESCRIPTION OF THE PREFERRED EMBODIMENT

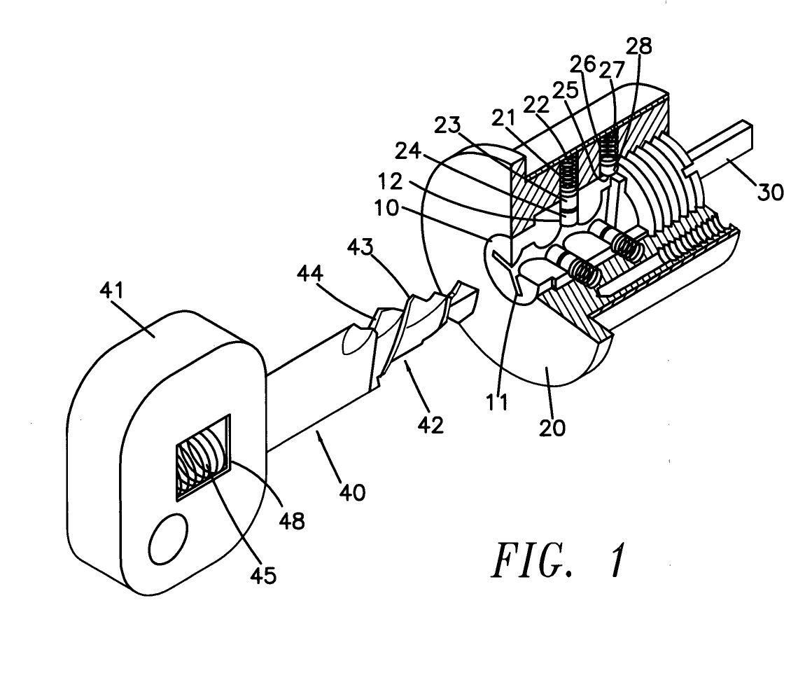

Please refer to FIG. 1, screw lock of this invention includes: a core 10, establishes a key hole 11 which present three forks screw shape; a body 20, encase a core 10 in interior; a lock bolt 30 connects with another end of core 10; and a key 40.

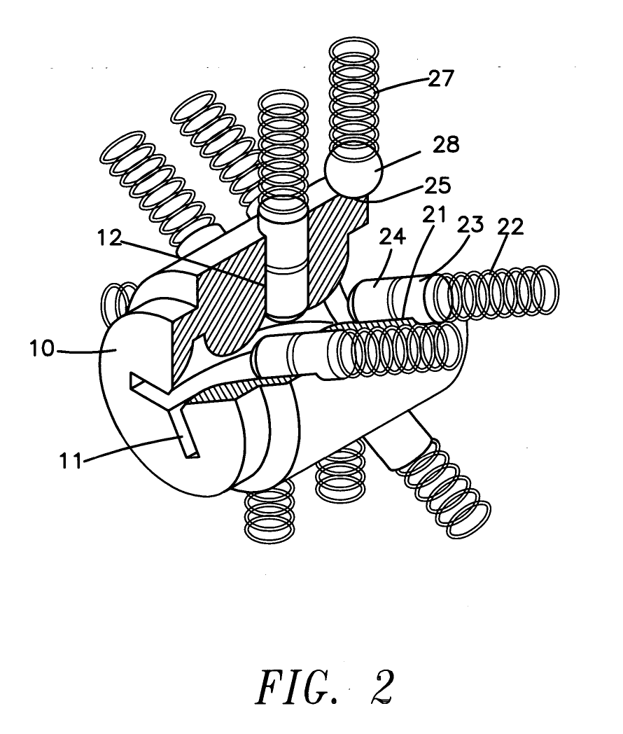

Core 10 and body 20 possess up pin hole 21 and down pin hole 12 which are connected up and down. As show in FIG. 1 and FIG. 2 up-down pin hole 21 [symbol] 12 present radiate arrangement method of uncertain angle inside core 10 and body 20, therein set sequent with pin spring 22 [symbol] up pin 23 and down pin 24 from outside to inside, thereof every down pin 24 extend individually into different position of the three forks screw shape key hole 11 by uncertain length; another, core 10 and body 20 possess a locating bead slot 25 and a locating bead hole 26 individually, where can put locating spring 27 and locating bead 28 to use to fix core 10 and body 20.

Key 40 as show in FIG. 1 includes a handle 41, and a three fork-like screw shank 42. On the position where three pieces of screw shape tooth peak 44 of key shank 42 homologize to every down pin 24 carve with tooth 43 of different depth to form pin gear rack of three forks screw shape arrangement.

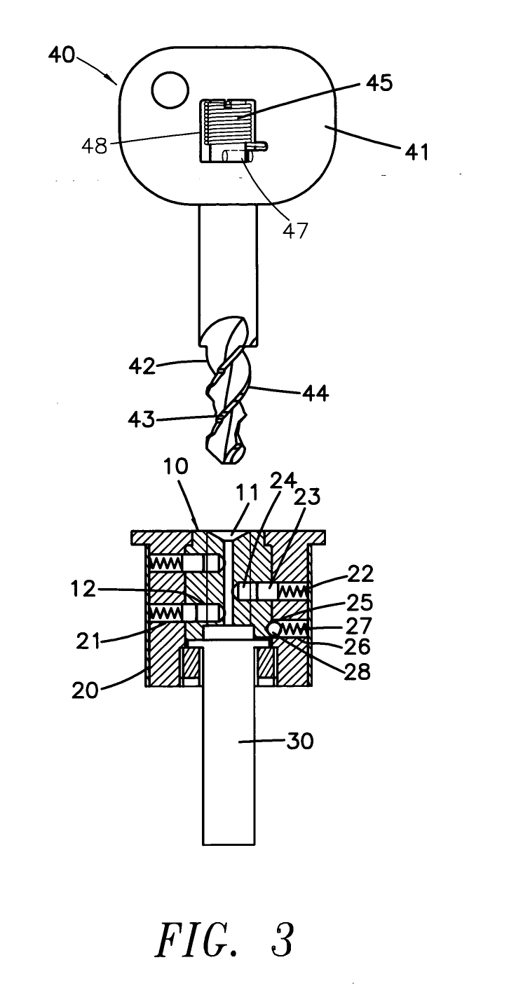

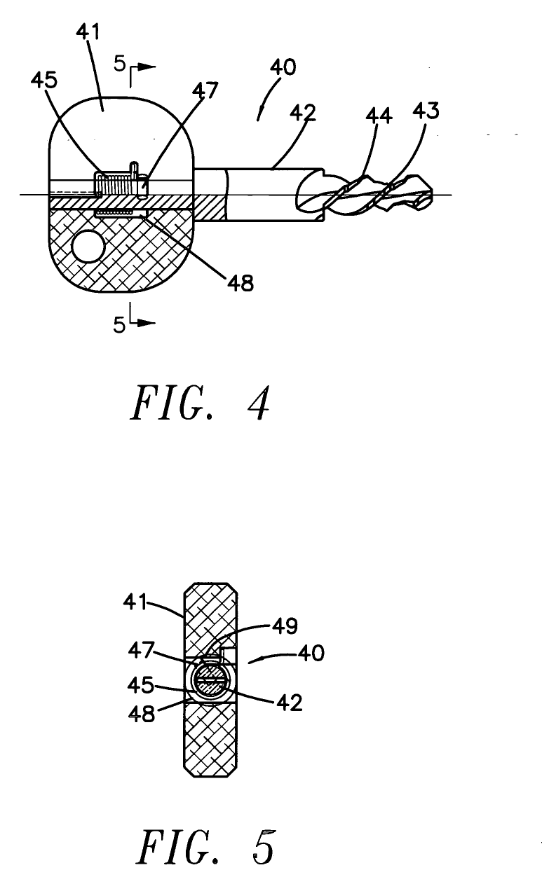

Please refer to FIG. 1 and FIG. 3, when use screw lock of this invention, the three fork-like screw shank 42 of key's 40 front end screw into the interior of key hole 11 which presents three forks screw shape. Each tooth 43 on key shank 42 just can push individually each down pins 24 inside key hole 11 from below. Down pins 24 jointly rise up pins 23 and compress pin springs 22. And depth of each tooth 43 just equal to the length of which the homologous down pin who push from below extend into key hole 11. The interface between down pin 24 pushed from below and up pin 23 and the interface between core 10 and body 20 just present the same plane. So the key 40 can drive the core 10 to rotate relative to body 20, and drive lock bolt 30 which connects with front end of the core 10 to rotate to an unlock position to achieve purpose of unlock.

The core among FIG. 1 to FIG. 3 is connected with a flake lock bolt. This constitution can be applied to be general door lock.

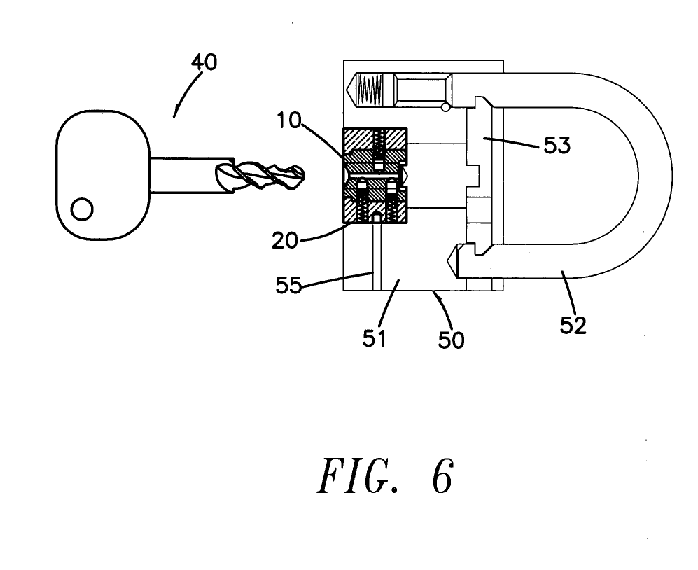

During the three forks shape screw lock connecting key shank 42 of key's 40 front end and key's 40 handle 41 by the way can rotate relatively is the best enable three fork-like screw shank 42 revolve into the interior of three forks shape cochleate key hole 11 to unlock conveniently for user. As show in FIG. 4 and FIG. 5, a eccentric hollow 48 is established on handle 41 but key shank 42 extend to the hollow 48 by the way doesn't locate at central line. And cover a twist spring 45 on whose outside. Twisted key shank 42 possesses elastic tendency of reverting to original position by the elasticity. Simultaneously instituting with a constraint rotary insert pin 47 beetles outward with a suitable length between the maximum and the minimum distances between key shank 42 and eccentric hollow 48 makes the constraint rotary insert pin 47 can rotate freely within a range of angle until it clashes the wall 49 of eccentric hollow 48. When user holds handle 41 to insert the key shank 42 into the interior of three forks cochleate key hole 11. Key shank 42 can rotate relatively to handle 41 can rotate automatically along the cochleate key hole 11 to screw into the, interior of three forks shape cochleate key hole. Thereafter, when user's hand rotates handle 41 till constraint insert pin 47 clashes the wall 49 of eccentric hollow will can bring key shank 42 and handle 41 rotate synchronously to an unlocking position to achieve unlocking movement. At last, when user exserts key 40 away key hole 11, the twisted spring desorbs whose elastic strain energy to force the key shank 42 to rotate reversely and revert to whose primitive position.

Besides, as show in FIG. 6, screw lock of this invention can use whose body 20 to lock and fix the body of a Chinese lock 51 of a U shape lock 50 by a bolt 55. The body of a Chinese lock 51 can supply to insert a U shape lock hook 52, and then core will be all right to connect and drive a lock hook control rod 53. Using key 40 to rotate the core 10 made use of driving the lock hook control rod 53 to move on groove's position where the U shape lock hook 52 and release the U shape lock hook 52. U shape lock stated above is widely used on motorcycle's wheel lock.

Screw lock supplied by this case can fit body of other type and other fittings too to be applied on every different occasion and use.

From above description we can understand, screw lock of this invention in three forks screw shape key hole, each down pin presents radiate arrangement of uncertain angle but not linear arrangement. It is not easy for thief to use lockout gun to find pin position. Still more, each down pin is hided on different position of narrow three forks screw crack. Want to move all of down pin to the height of unlock is extremely difficult in fact. So it is a kind of construct which has very high security and can truly prevent unlocking unlawfully.

Besides, middle hole encircled and formed by multiple pieces of screw shape tooth peak is very small. But slide distance of each down pin lengthens out to twice of diameter of middle hole. So wishing to move each down pin to slide to unlock position from key hole is already impossible theoretically. And if the tool can insert in this core has enough rigidity then whose size almost already stuff full key hole but unable to move. Or the one is tinier but still has space to move then already is quite weak hard to move each down pin. Still more, want to push aside all pins must take unlock tool to turn to slide direction of each down pin to put forth effort. And three forks key hole just can resist whose turn. Then can effectively promote security of preventing unlocking unlawfully of lock.

Synthesize above description, multiple fork screw lock of this invention possesses below advantages:

(1) Possesses three lines screw shape key hole, and each pin obeys uncertain angle radiate shape arrangement. Number of pin also exceed too much, and distributes on circumference's each direction, can effectively promote security;

(2) Crack on installation position of pin is narrow. It's more probable to effectively resist lockout gun and special tool to move pin;

(3) Effective distance of pin is bigger (about 2.5 mm). Section number which every set pin can use is comparatively more, can greatly reduce probability of unlock by try and error method. For example, every section's different distance counted by 0.5 mm, effective section number which pin of every set can obtain has five sections. Whole set of lock counted by 9 sets of pin. The biggest arrangement and assemblage set number can obtained is every set of pin section number multiplies power of pin number (namely ninth power of five), namely the most set numbers of arrangement and assemblage have 1953125 sets.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A kind of screw lock, which comprises:
a body;
a core which can be mounted inside said body by rotation way, establishing with a key hole of three forks screw shape on position of whose axial center, and setting with a lot of pins which present radiate shape arrangement and extend into different positions of interior of key hole by uncertain length inside axle center; and
a key, including a handle and three fork-like screw shank which is on front end of said handle, said key shank can tight airtight to screw into interior of said key hole, and on position where homologize to each pin on said key shank individually carving with a tooth of extending length of homologous said pin, making use of pushing each pin to a position where said core can be drove to rotate by said key.

2. A screw lock as claimed in claim 1, wherein said key shank and said handle are connected by relative rotation way.

3. A screw lock as claimed in claim 2, wherein establishing an eccentric hollow on said handle and covering a twist spring outside said key shank extends into said eccentric hollow, twisted key shank possesses elastic tendency of reverting to original position by the elasticity, simultaneously instituting with a constraint rotary insert pin beetles outward, the beetled length is between the maximum and the minimum distances between said key shank and said eccentric hollow, to make said key shank can rotate relatively to said handle within a setting range of angle.
